(19) United States
(12) Patent Application Publication
(10) Pub. No.: US 2025/0155307 A1
(43) Pub. Date: May 15, 2025

(54) DIFFERENTIAL OIL-FILLED PRESSURE TRANSDUCERS WITH COMPENSATING CAPSULE

(71) Applicant: KULITE SEMICONDUCTOR PRODUCTS, INC., Leonia, NJ (US)

(72) Inventors: Robert Gardner, Westwood, NJ (US); Louis DeRosa, Saddle River, NJ (US)

(21) Appl. No.: 18/508,331

(22) Filed: Nov. 14, 2023

(51) Int. Cl. G01L 13/04; G01L 27/00

(52) U.S. Cl. CPC G01L 13/04; G01L 27/002

(57) ABSTRACT

The disclosed technology includes an oil-filled pressure transducer assembly and an oil-filled compensating sensing element disposed near one another and attached to a common housing. The oil-filled pressure transducer assembly may receive and measure pressure media via a main input port and reference pressure via a reference input port. The compensating sensing element may be isolated from the pressure media. In certain example implementations, the compensating sensing element is configured to measure certain common error phenomena that are also measured by the oil-filled pressure transducer assembly, for example, due to acceleration, temperature, and/or vibration. In certain implementations, the signal measured by the compensating sensing element may be subtracted from one or more signals measured by the oil-filled pressure transducer assembly to provide a compensated output signal.

### FIELD

The disclosed technology relates to differential pressure transducers, and more particularly to oil-filled differential transducers having a main differential transducer and a compensating transducer capsule configured to compensate for measurement errors in the main differential transducer.

### BACKGROUND

Oil filled transducers can be particularly well-suited for use in harsh, conductive, and/or corrosive environments for pressure sensing applications. In such transducers, pressure is received by a (typically metal) diaphragm and transferred to an oil-filled chamber, which transfers the pressure to an internal sensing element within the oil-filled chamber. Thus, the sensing element can be isolated from the pressure media and protected by the oil. However, the performance of such a transducer is susceptible to measurement error due to factors such as acceleration, vibration, etc.

A need still exists for robust transducers in which measurement errors can be reduced or eliminated.

### BRIEF SUMMARY

Some or all of the above needs may be addressed by certain implementations of the disclosed technology. Certain implementations of the disclosed technology may include systems and methods for a differential pressure sensor device with a compensating sensor.

In one example implementation of the disclosed technology, a compensated oil-filled pressure transducer assembly is provided. The assembly includes a housing with a main input port configured to receive a main pressure, and a reference input port configured to receive a reference pressure. The assembly includes an oil-filled differential pressure sensing capsule attached to the housing. The oil-filled differential pressure sensing capsule is configured to output a differential pressure signal responsive to the main pressure received at the main input port and the reference pressure received at the reference input port, and a common error signal responsive to a common error stimulus acting on the oil-filled differential pressure sensing capsule. The common error stimulus can include one or more of: vibration, acceleration, and temperature. The oil-filled differential pressure sensing capsule includes a differential pressure sensing element that can be characterized by a first side in communication with the main input port and a second side in communication with the reference input port. The assembly includes an oil-filled compensating capsule configured to output a compensation signal responsive to the common error stimulus. The assembly also includes a compensation output circuit in communication with the oil-filled differential pressure sensing capsule and the oil-filled compensating capsule. The compensation output circuit is configured to output a compensated pressure output signal based on a difference between the differential pressure signal and the common error signal of the oil-filled differential pressure sensing capsule and the compensation signal of the oil-filled compensating capsule.

In another example implementation, a compensated oil-filled differential pressure transducer assembly is provided. The assembly includes a housing including a main input port configured to receive a main pressure and a reference input port configured to receive a reference pressure. The assembly includes an oil-filled main pressure sensing capsule attached to the housing and configured to output a main pressure signal responsive to the main pressure received at the main input port and a first common error signal responsive to a common stimulus acting on the oil-filled main pressure sensing capsule. The common stimulus can include one or more of: vibration, acceleration, and temperature. The oil-filled main pressure sensing capsule includes a main pressure sensing element in communication with the main input port. The assembly includes an oil-filled reference pressure sensing capsule mounted in a same orientation as the oil-filled main pressure sensing capsule. The oil-filled reference pressure sensing capsule is configured to output a reference pressure signal responsive to the reference pressure received at the reference input port and a second common error signal responsive to the common stimulus acting on the oil-filled reference pressure sensing capsule. The oil-filled reference pressure sensing capsule includes a reference pressure sensing element in communication with the reference input port.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

FIG. 1 depicts a cross-sectional side-view of a conventional enclosed and oil-filled sensor assembly.

FIG. 2 depicts a cross-sectional side-view of an oil-filled transducer embodiment having an isolated compensating capsule, according to an example implementation of the disclosed technology.

FIG. 3A is a cross-sectional side-view of an oil-filled differential transducer assembly having an isolated (differential) compensating capsule, according to an example implementation of the disclosed technology.

FIG. 3B is a cross-sectional side-view of an oil-filled differential transducer assembly having differential compensating capsule that can be exposed on one or more sides to main pressure, according to an example implementation of the disclosed technology.

FIG. 3C is a cross-sectional side-view of an oil-filled differential transducer assembly having differential compensating capsule that can be exposed on one or more sides to reference pressure, according to an example implementation of the disclosed technology.

FIG. 4A is cross-sectional side-view illustration of a conventional pressure transducer assembly in which the transducer elements are oriented in opposite directions.

FIG. 4B is a cross-sectional side-view of an oil-filled transducer having a main oil-filled transducer exposed to main pressure, and a reference transducer exposed to a reference pressure, where each transducer is substantially similar and mounted to have a substantially similar orientation, in according to an example implementation of the disclosed technology.

FIG. 5A is a block diagram of a compensation output circuit, according to an example implementation of the disclosed technology.

FIG. 5B is an example schematic diagram of an active compensation output circuit, according to an example implementation of the disclosed technology.

FIG. 5C is an example schematic diagram that illustrates the use of a passive circuit to produce a compensated output, according to an example implementation of the disclosed technology.

### DETAILED DESCRIPTION

The disclosed technology includes a differential pressure transducer assembly having an oil-filled differential pressure sensing capsule and a substantially equivalent oil-filled differential compensating sensing capsule mounted near one another in the assembly. In certain implementations, the differential pressure sensing capsule may receive main pressure on a first side of a associated sensor diaphragm via a first oil-filled cavity and a first protective diagram that is in communication with the main pressure media. In certain implementations, the differential pressure sensing capsule may receive reference pressure on a second side of the sensor diaphragm via a second oil-filled cavity and a second protective diagram that is in communication with the reference pressure. Thus, the received main and reference pressures may be transferred to respective sides of the pressure sensing element of the differential pressure sensing capsule via respective oil-filled cavities in communication with respective protective diaphragms.

In accordance with certain exemplary implementations of the disclosed technology, the differential compensating sensing capsule may be substantially identical to the differential pressure sensing capsule and may be configured in one of three different modes: (1) isolated; (2) exposed on both sides to main pressure; or (3) exposed on both sides to reference pressure. The differential compensating sensing capsule may have a third protective diaphragm in communication with a third oil-fill cavity in communication with a compensating sensor diaphragm. The differential compensating sensing capsule may have a fourth protective diaphragm in communication with a fourth oil-fill cavity in communication with the compensating sensor diaphragm. In the first (isolated) mode, the compensating pressure sensing capsule may be configured to have both of the third and fourth protective diaphragms closed off and/or isolated from any external pressures. In the second mode, the compensating pressure sensing capsule may be configured to have both of the third and fourth protective diaphragms exposed to main pressure. In the third mode, the compensating pressure sensing capsule may be configured to have both of the third and fourth protective diaphragms exposed to reference pressure.

In accordance with certain exemplary implementations of the disclosed technology, and in the first (isolated) mode, the differential compensating sensing capsule may be configured to measure certain common error phenomena that act on both the differential pressure sensing capsule and differential compensating sensing capsule while being insensitive to pressure fluxuations in the pressure media. In certain example implementations, the signal measured by the differential compensating sensing element may be subtracted from the signal measured by the differential pressure sensing element to provide an output signal that is compensated for common error errors, for example, due to acceleration and/or vibration.

In accordance with certain exemplary implementations of the disclosed technology, the other example modes (i.e., where the differential compensating sensing capsule is exposed on both sides to main pressure or exposed on both sides to reference pressure) may be utilized to compensate for nonlinearities, for example, due to high line pressures.

Some implementations of the disclosed technology will be described more fully hereinafter with reference to the accompanying drawings. This disclosed technology may be embodied in many different forms and should not be construed as limited to the implementations set forth herein.

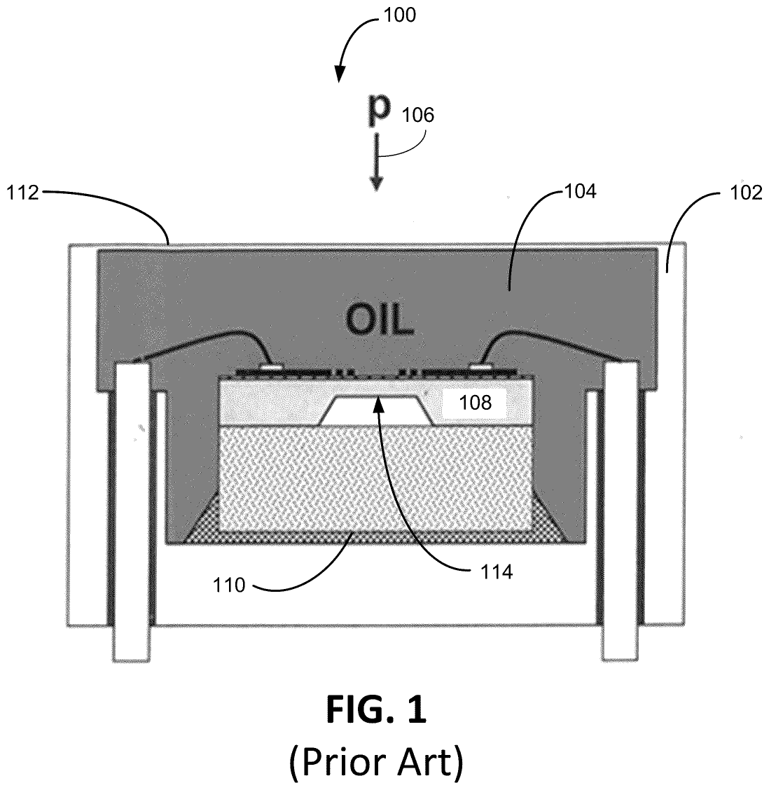

FIG. 1 depicts a conventional oil-filled transducer assembly 100 having a single sensing element 108 placed inside a housing 102 that is filled with oil 104. The sensing element 108 typically includes piezoresistive elements arranged in Wheatstone bridge configuration and in communication with a small deflecting membrane diaphragm 114 of the sensing element 108. External pressure 106 is transferred from the (typically metal) isolation diaphragm 112, through the oil 104 (acting as an incompressible fluid), and to the small deflecting membrane diaphragm 114. Thus, the isolation diaphragm 112 and oil 104 act to isolate the sensing element 108 from harsh or corrosive pressure media. The small membrane diaphragm 114 on the sensing element 108 has a small mass that, together with the mass of the oil 104 and/or the isolation diaphragm 112, can introduce measurement errors dependent on the magnitude and orientation of the acceleration and vibration acting on the assembly 100.

U.S. Pat. No. 6,293,154, entitled “Vibration Compensated Pressure Sensing Assembly,” assigned to Kulite Semiconductor Products, Inc., and incorporated herein by reference as if presented in full, describes a technology for performing acceleration/vibration compensation on a sensing element that does not utilize the protective oil filling or isolation diaphragm. However, as discussed above, certain harsh environmental applications may require the use of an oil-filled transducer, such as depicted in FIG. 1. Compensating for acceleration/vibration in an oil-filled transducer has its own unique set of challenges, due at least in part to the mass of the oil that can be significantly larger than the mass of a typical membrane diaphragm. Thus, in certain applications, the oil in an oil-filled transducer may be a dominant factor in the acceleration- and vibration-related errors.

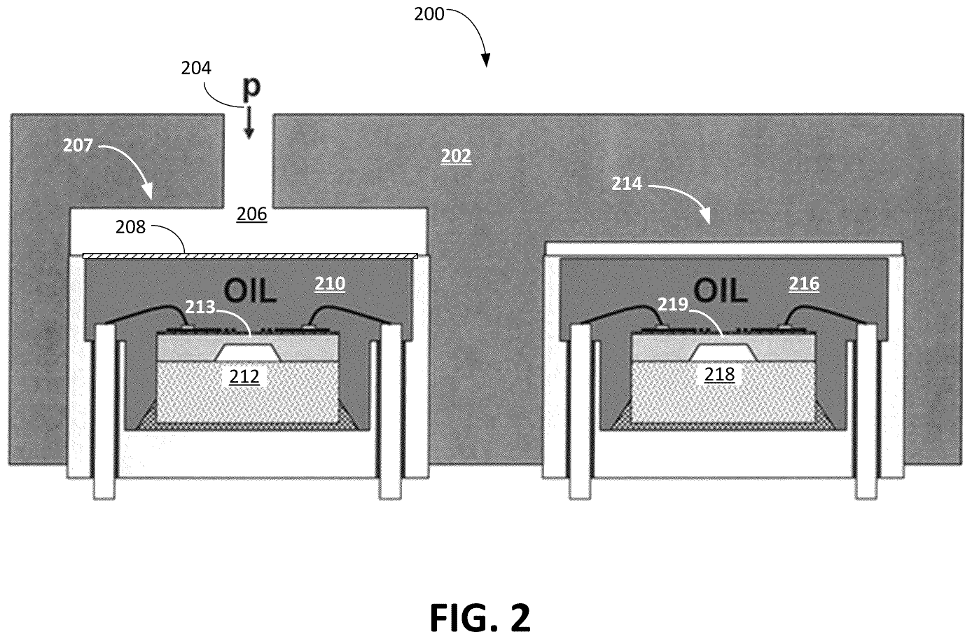

In accordance with certain example implementations of the disclosed technology, acceleration/vibration errors may be reduced or eliminated by the introduction of a separate, isolated, oil filled compensation transducer capsule, as will now be described below with reference to FIGS. 2-6.

FIG. 2 depicts a cross-sectional side-view of an oil-filled transducer assembly 200 in accordance with certain example implementations of the disclosed technology. The assembly 200 may include a pressure sensing capsule 207 having a pressure sensing element 212 sealed within in a first oil-filled cavity 210. The assembly also can include a compensating capsule 214 having a separate compensating sensing element 218 sealed with a second oil-filled cavity 216. In certain example implementations, the pressure sensing element 212 and the compensating sensing element 218 may be disposed near one another and attached to a common housing 202 so that they are subjected to the same acceleration and vibrational forces.

In certain example implementations, the pressure sensing element 212 and the compensating sensing element 218 may be practically identical, with the first membrane diaphragm 213 of the pressure sensing element 212 having essentially the same mass and configuration as the second membrane diaphragm 219 of the compensating sensing element 218. In certain example implementations, a same amount of oil may be utilized in both the first oil-filled cavity 210 and the second oil-filled cavity 216 so that equal acceleration and vibrational forces due to the oil may be measured by both elements 212, 218.

In accordance with certain example implementations of the disclosed technology, the pressure sensing element 212 may receive pressure 204 via an input port 206 exposed to pressure media. The pressure 204 may impinge on a protective diagram 208 that is configured to transfer the pressure through the first oil-filled cavity 210 and to the first membrane diaphragm 213 of the pressure sensing element 212. The compensating sensing element 218 may be communication with the second-oil filled cavity 216 that is isolated from the pressure 204.

In certain example implementations, the compensating capsule 214 is configured to measure certain common error phenomena that act on both the pressure sensing element 212 and the compensating sensing element 218, while being isolated from the pressure 204 fluxuations in the pressure media. In certain example implementations, the signal measured by the compensating capsule 214 may be subtracted from the signal measured by the pressure sensing capsule 207 to provide an output signal that is compensated for common error errors, for example, due to acceleration and/or vibration. In other words, the compensating capsule 214 may be utilized to cancel-out the effects of acceleration and vibration sensitivity of the assembly 200 by exposing only the pressure sensing element 212 to the pressure 204 to be measured. In certain example implementations, both oil-filled pressure sensing capsules 207, 214 may be manufactured to be extremely small, may be located as close as practically possible to each other, and may be mounted with the same orientation.

In accordance with certain example implementations of the disclosed technology, any conventional wafer processing techniques which enable dialectically isolated piezoresistive sensor elements to be formed on semiconductor material using dielectric films of SiO2 or the like may be used to form the sensing elements 212, 218. In certain example implementations, Wheatstone bridges utilizing piezoresistive elements may be formed and utilized as the sensing components in the elements 212, 218. In some implementations, a Wheatstone bridge may include four oversized P+ diffused silicon electrical contact areas or fingers which may be located in non-active areas of the wafers associated with the piezoresistors of the respective sensing elements 212, 218. It should be understood that the active regions of the sensing elements 212, 218 can be defined as those portions that are deflectable by the membrane diaphragms 213, 219, while the remaining portions may be referred to as the non-active regions.

In certain example implementations, the sensing elements 212, 218 may be installed in the housing 202 by adhesive bonding. In some applications, a relatively hard epoxy-type adhesive can be utilized to secure the sensing elements 212, 218 to the housing 102. In certain applications, such as in high-temperature environments, the sensing elements 212, 218 may be secured using glass frit bonding. The use of such adhesives and/or bonding can enable assembly and packaging using standard high-volume semiconductor packaging techniques, which can include automated adhesive dispensing, glass frit dispensing, chip pick-and-place, and wire bonding/welding for making electrical interconnections between the sensing elements 212, 218 and their respective headers.

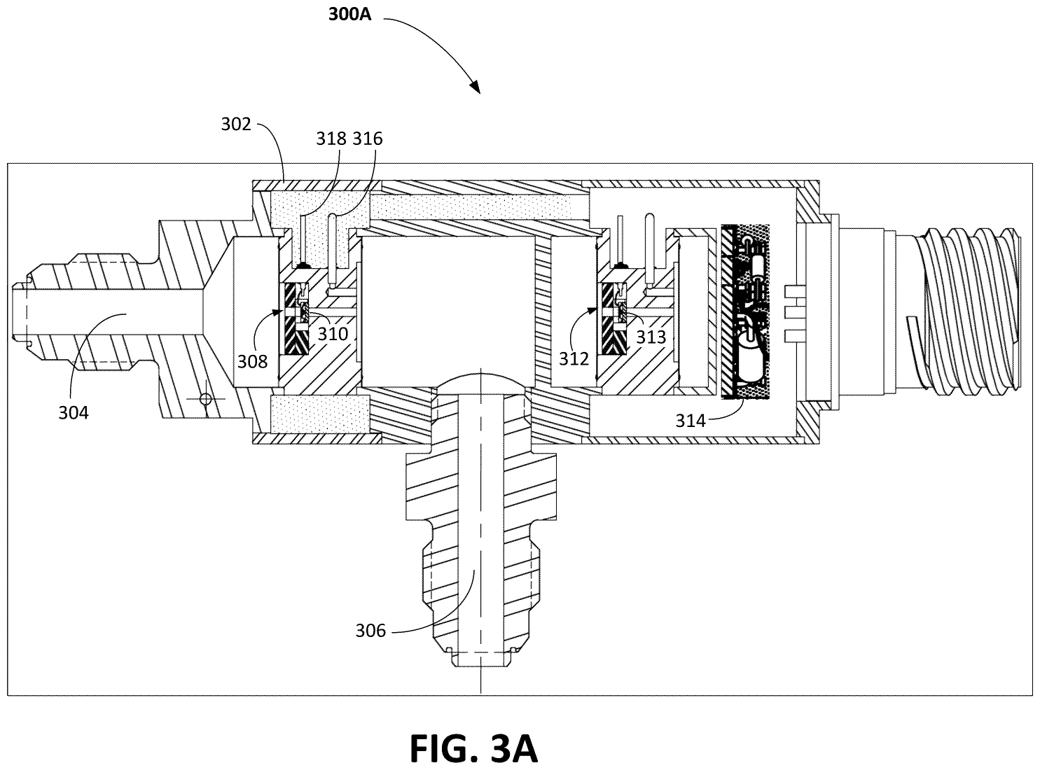

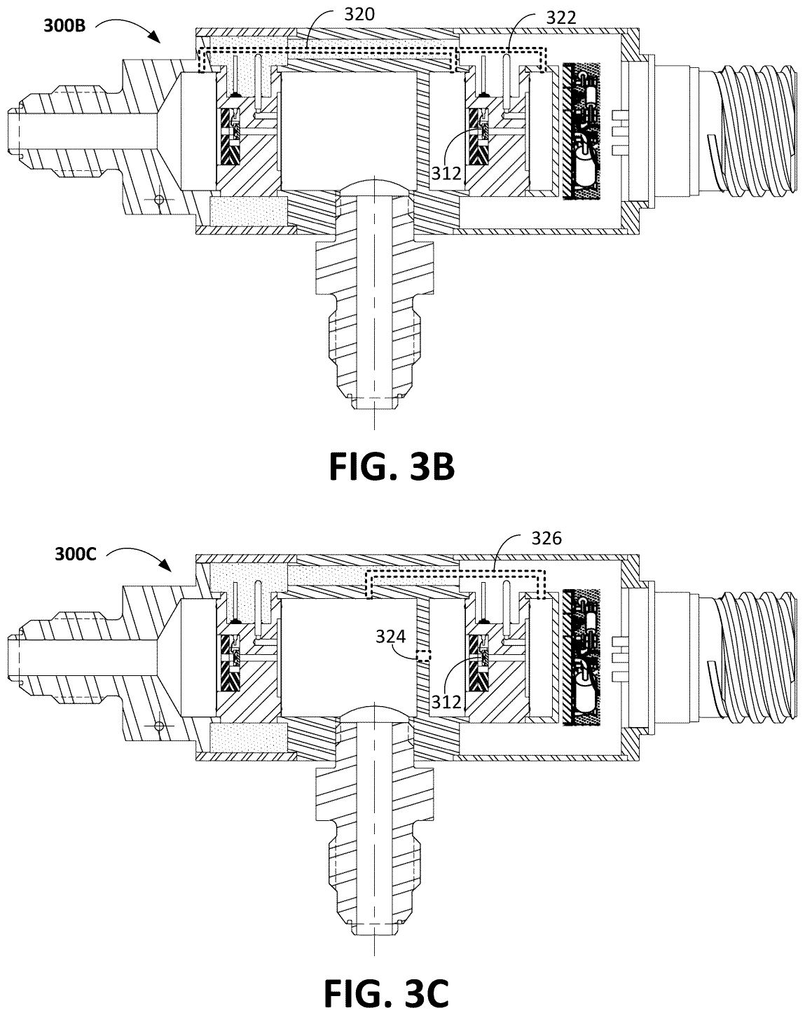

The oil-filled transducer assembly 200 as illustrated in FIG. 2 includes single-ended (non-differential) sensing elements 212, 218 as discuss in U.S. Pat. No. 11,359,985, entitled “Oil-Filled Transducers with Isolated Compensating Capsule,” assigned to Kulite Semiconductor Products, Inc., and incorporated herein by reference as if presented in full. As will be discussed below with reference to FIG. 3A-FIG. 6, certain implementations of the discussed technology provide certain advances and improvements for differential sensing elements and compensating elements to enable compensated differential pressure measurement.

FIG. 3A depicts a cross-sectional side-view illustration of an oil-filled differential transducer assembly 300A, in accordance with certain exemplary implementations of the disclosed technology. The assembly 300A can include an oil-filled differential pressure sensing capsule 308 having a differential pressure sensing element 310 configured for measuring differential pressure between the main input port 304 and the reference input port 306. The assembly 300A also includes an isolated oil-filled differential compensating capsule 312 that can be configured to measure common stimuli acting on the assembly 300A.

In accordance with certain exemplary implementations of the disclosed technology, the compensation output circuit 314 may utilize the common error signal measured by the isolated oil-filled differential compensating capsule 312 to reduce or eliminate measurement errors due to common stimuli such as vibration, acceleration, and/or temperature acting on the transducer assembly 300A. In certain implementations, the common error signal (or a scaled version thereof) may be subtracted from the signal measured by the oil-filled differential pressure sensing capsule 308 to achieve the compensation.

In accordance with certain exemplary implementations of the disclosed technology, the oil-filled differential pressure sensing capsule 308, the isolated oil-filled differential compensating capsule 312, and the compensation output circuit 314 may be contained in a common housing 302. In certain implementations, all or part of the compensation output circuit 314 may be external to the transducer assembly 300A.

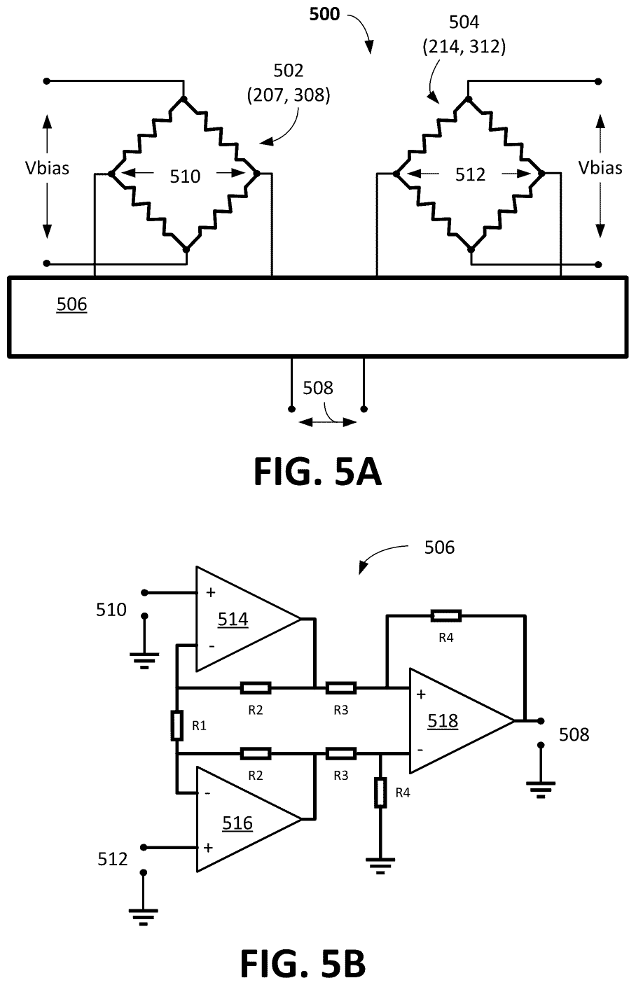

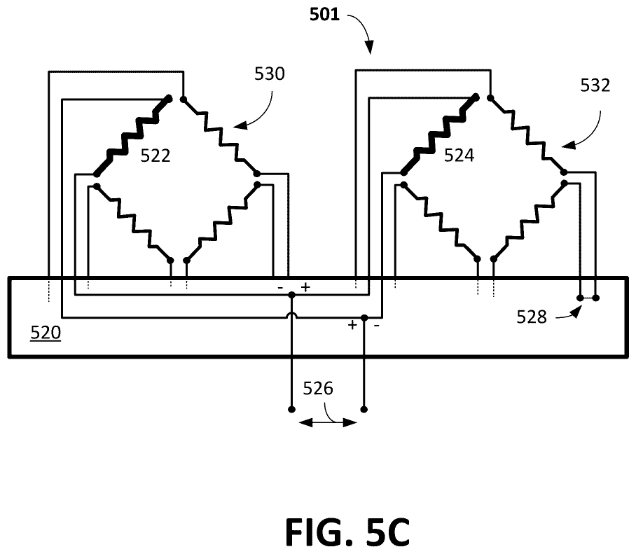

In accordance with certain example implementations of the disclosed technology, each capsule 308, 312 may include some or all of the same components, may be mounted in similar or identical headers, and may be installed in the common housing 302. For example, each capsule 308, 312 may include a sealable oil tube 316 for filling the respective oil cavities with oil and for evacuating entrained air-bubbles from the oil before sealing the oil tube 316. In addition, each capsule 308, 312 may include pins 318 for supplying power to and/or receiving signals from the respective sensing elements 310, 313 via electrical wires or similar interconnections to an associated circuit, as will be discussed below with respect to FIGS. 5A-C.

In certain example implementations, protective diaphragms on the sensing capsule 313 may not be required on the compensating capsule 312 since it is intended to be isolated from pressure media. However, some implementations may include the oil-filled cavities and the one or more protective diaphragms on the compensating capsule 312 in an identical or substantially equivalent configuration as the oil-filled differential pressure sensing capsule 308 so that both capsules 308, 312 respond equally to the same common stimuli.

In certain example implementations, both the oil-filled differential pressure sensing capsule 308 and the compensating capsule 312 include respective sensing elements 310, 313 sealed within first and second respective oil-filled cavities (such as cavities 210 and 216, as discussed above with respect to FIG. 2). In certain example implementations, the sensing elements 310, 313 may be practically identical, with essentially the same amount of oil utilized so that equal acceleration and vibrational forces due to the oil (and membranes and/or diaphragms) may be measured by both capsules 308, 312.

As depicted in FIG. 3A, the sensing element 310 of the oil-filled differential pressure sensing capsule 308 may receive main pressure on a first side of the sensing element 310 via the main input port 304 exposed to pressure media, and reference pressure on a second side of the sensing element 310 via the reference input port 306. The main and/or reference pressure(s) may be directed by the corresponding input ports 304, 306 to corresponding protective diagrams of the sensing element 310 that are configured to transfer the pressure through corresponding oil-filled cavities and to a membrane diaphragm of the sensing element 310. As discussed above with respect to FIG. 2, the compensating sensing capsule 312 may have a sensing element 313 in communication with corresponding oil filled cavities that are isolated from the pressure media.

In certain example implementations, the oil-filled differential compensating capsule 312 may be configured to measure certain common error phenomena that act on both the oil-filled differential compensating capsule 312 and the oil-filled differential pressure sensing capsule 308, while being insensitive to pressure fluxuations in the pressure media by intentionally isolating the compensating capsule 312 from the pressure media.

In accordance with certain example implementations of the disclosed technology, oil-filled differential pressure sensing capsule 308 may exhibit sensitivity to differential pressure at the main input port 304 and the reference input port 306 and all other contributors such as acceleration, vibration, oil volume, oil mass, temperature, etc., while the compensating capsule 312 may only exhibit sensitivity to acceleration, vibration, oil volume, oil mass, temperature, etc., and not to pressure. In certain example implementations where the two capsules 308, 312 are identical in their construction, their inherent sensitivity to acceleration, vibration, oil volume, oil mass, temperature, etc., may be practically identical. Thus, by subtracting the signal of the compensating capsule 312 from the signal of the sensing capsule 308, errors due to acceleration, vibration, oil volume, oil mass, temperature, etc., may be eliminated (or reduced).

FIG. 3B depicts a cross-sectional side-view of an oil-filled differential transducer assembly 300B according to certain implementations, in which the differential compensating capsule 312 may be exposed on one or more sides to main pressure via an optional first bypass port 320 and/or an optional second bypass port 322, according to an example implementation of the disclosed technology.

FIG. 3C depicts a cross-sectional side-view of an oil-filled differential transducer assembly 300C according to certain implementations, in which the differential compensating capsule 312 may be exposed on one or more sides to reference pressure via an optional third bypass port 324 and/or an optional fourth bypass port 326, according to an example implementation of the disclosed technology.

In certain implementations, one or more of the optional bypass ports 320, 322, 324, 326 may comprise channels formed through cavity walls (such as illustrated by the bypass port 324) and/or may include tubes, etc., (such as illustrated by the bypass port 326). In certain implementations, one or more of the optional bypass ports 320, 322, 324, 326 may be configured to be disabled or blocked via one or more plugs, welds, etc. In accordance with certain implementations of the disclosed technology, one or more of the optional bypass ports 320, 322, 324, 326 may be included to help eliminate or compensate for certain nonlinearities that can occur in measured pressure signals, such as in measurement scenarios where sensing element 310 is exposed to high common mode pressure.

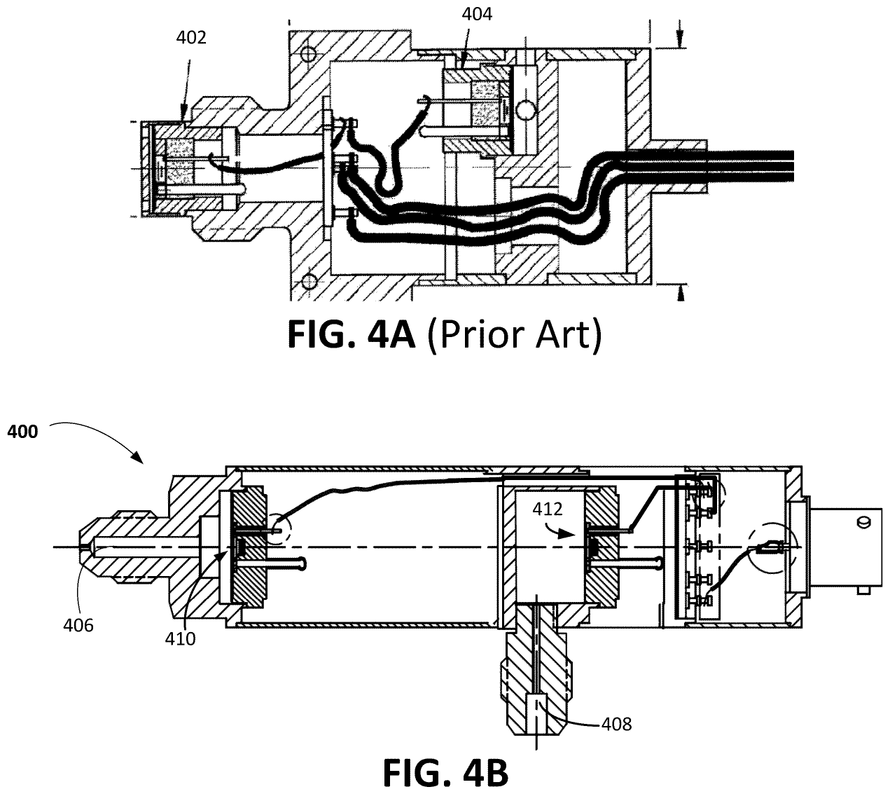

FIG. 4A depicts a common application of a Half Bridge differential pressure transducer assembly, as disclosed in U.S. Pat. No. 8,191,425. In this configuration two absolute pressures are measured. For example, a main sensor capsule 402 measures a main pressure and a reference sensor capsule 404 measures a reference pressure. These measurement readings are then electrically subtracted to measure the differential pressure between the main pressure and the reference pressure. As shown in FIG. 4A, the two capsules 402, 404 are mounted back-to-back in the assembly so that they face in opposite directions. In this configuration, acceleration or vibration impacts the capsules 402, 404 in opposite directions. For instance, an acceleration to the left would act into the face of capsule 402 but out of the face of capsule 404. When these signals are electrically subtracted the effect of the acceleration is thus doubled.

FIG. 4B depicts a cross-sectional side-view illustration of an differential oil-filled transducer assembly 400 in accordance with certain exemplary implementations of the disclosed technology, where a main oil-filled transducer capsule 410 is configured to be exposed to main pressure via a main pressure port 406, and a reference transducer capsule 412 is configured to be exposed to a reference pressure via a reference pressure port 408, where the transducer capsules 410, 412 are substantially similar and mounted to have a substantially similar orientation. In this orientation, acceleration or vibration acts on both capsules 410, 412 in the same way, so when respective measurement signals from the capsules 410, 412 are subtracted from each other, the signal effect of common acceleration or vibration cancels out.

Additional components may include interconnects, circuit boards, electronics, connectors, and/or additional housing components utilized to interface with and/or secure the capsules 410, 412 and/or other components.

In accordance with certain example implementations of the disclosed technology, and as may be applicable to each of the oil-filled transducer capsules disclosed herein, since the oil may be a dominant factor in the acceleration- and vibration-related errors, it may be preferable to use as little oil as possible in each chamber and in the associated filling tubes. In certain example implementations, the height of the oil chambers may range from about 1 mm to about 2 mm. In certain implementations, the height of the oil chambers may range from about 2 mm to about 3 mm. In certain implementations, the height of the oil chambers may range from about 3 mm to about 4 mm.

In certain example implementations, the height of the oil chamber of the main oil-filled transducer capsule 408 may differ from that of the oil chamber of the compensating transducer capsule 412. In certain example implementations, it may be preferable to have the volume of oil in the oil chamber of the main sensing transducer capsule 408 to be the same as the volume of oil in the oil chamber of the compensating transducer capsule 412. In one example implementation, the volume of oil in the chambers may differ by less than 1%. In another example implementation, the volume of oil in the chambers may differ by between about 1% and about 2%. In another example implementation, the volume of oil in the chambers may differ by between about 2% and about 3%. In another example implementation, the volume of oil in the chambers may differ by between about 3% and about 4%. In another example implementation, the volume of oil in the chambers may differ by between about 4% and about 5%. In another example implementation, the volume of oil in the chambers may differ by between about 5% and about 6%. In another example implementation, the volume of oil in the chambers may differ by between about 6% and about 7%. In another example implementation, the volume of oil in the chambers may differ by between about 7% and about 8%. In another example implementation, the volume of oil in the chambers 4 may differ by between about 8% and about 9%. In another example implementation, the volume of oil in the chambers may differ by between about 9% and about 10%. In another example implementation, the volume of oil in the chambers may differ by between about 10% and about 15%. In another example implementation, the volume of oil in the chambers may differ by between about 15% and about 20%. In another example implementation, the volume of oil in the chambers may differ by between about 20% and about 25%.

Since air entrained in the oil and/or trapped in the oil-chambers and/or filling tubes can expand or contract with temperature (possibly creating additional temperature-related errors), it may be preferable (and in some cases-critical) to evacuate the air from the oil-filled cavities and associated oil-containing passages prior to (or during) sealing the oil-filling tubes. In certain example implementations, it may be preferable to fill the oil chamber, evacuate the air, and seal the oil-filling tubes before mounting the sensing elements and associated components to their respective headers.

In accordance with certain example implementations of the disclosed technology, it may preferable to keep the capsule headers identical (as much as possible) to promote an equal response to acceleration, vibration, and temperature for each of the oil-filled main transducer capsule 408, the main oil-filled compensating transducer capsule 412, the reference oil-filled compensating transducer capsule 414, and/or the oil filled reference transducer capsule 416 (or 418).

FIG. 5A depicts an example block diagram of a circuit 500 for compensating an output signal 510 of a differential oil-filled sensing capsule 502 with an output signal 512 from a differential oil-filled compensating capsule 504. In certain implementations, the circuit 500 may be embodied as the compensation circuit 314 as shown in FIG. 3A, and may be particularly well suited for transducers having differential sensing and isolation capsules In certain example implementations, a circuit 506 (for example, as shown in FIG. 5B) may subtract the differential oil-filled compensating capsule 504 output signal 512 from the differential oil-filled sensing capsule 502 output signal 510 using active signal processing to produce a compensated output 508.

FIG. 5B is a schematic diagram of an active compensation output circuit 506, according to an example implementation of the disclosed technology. In this example embodiment, the respective output signals 510 and 512 from the respective capsules 502, 504 (as shown in FIG. 5A) may be input into respective voltage follower input buffers 514, 516. In accordance with certain example implementations of the disclosed technology, a differential amplifier 518 may receive the outputs from the input buffers 514, 516, and may be utilized to produce a compensated output 508 that is proportional to the output signal 510 from the differential oil-filled sensing capsule 502 minus the output signal 512 from the differential oil-filled compensating capsule 504.

FIG. 5C depicts an example block diagram 501 of an alternative arrangement for compensating a differential or absolute oil-filled sensing capsule 530 with a differential (see FIGS. 3A-3C) or absolute (see FIGS. 4A-4B) oil-filled compensating capsule 532 utilizing a simple passive circuit 520 to produce a compensated output 526. In this example implementation, one or more of the various legs of the sensing capsules 530, 532 may be separately connected to the passive circuit 520, which may be configured to allow for selected legs to be connected to produce the compensated output 526. For example, and for illustrative purposes only, a piezoresistor 522 of the oil-filled sensing capsule 530 is shown connected out-of-phase via the passive circuit 520 with the corresponding piezoresistor 524 of the oil-filled compensating capsule 532. In this (over-simplified) example, the piezoresistor 522 of the oil-filled sensing capsule 530 may respond to pressure, acceleration, vibration, and temperature while the piezoresistor of the oil-filled compensating capsule 504 may be responsive to the same acceleration, vibration, and temperature—but not the pressure. By connecting the piezoresistors 522 524 in a similar arrangement, the compensated output 526 may include only the response to the pressure. Those having skill in the art will recognize that other components, such as capacitors, resistors, biasing voltage source(s), switches and/or additional interconnections 528, etc., may be utilized in the circuit 520.

The various transducer and compensation circuit arrangements disclosed herein can provide for certain improvements to pressure sensing technology that enable differential and/or single-ended pressure sensing elements to be configured for differential pressure measurements while providing compensation to reduce or eliminate error due to common stimuli.

In accordance with certain example implementations of the disclosed technology, the oil-filled sensing capsules and/or the oil-filled compensating capsules may be or include hermetically sealed sensors. It should be understood that other structures can be used without departing from the scope of the disclosed technology.

In accordance with certain example implementations of the disclosed technology, various combinations of the (differential and/or single ended) pressure sensing and compensating capsules may be attached to the housing in a linear, side-by-side, and/or vertically stacked arrangement.

In certain implementations, the oil-filled compensating capsule may be a differential compensating capsule. In other implementations, the compensating capsule may be a non-differential (singled ended) compensating capsule, for example to match the configuration of the main and/or reference pressure sensing capsule.

In certain implementations, the oil-filled compensating capsule may be isolated from the main input port and the reference input port. In other example implementations, the oil-filled compensating capsule may be in communication with the main input port and/or the reference input port.

In certain implementations, the oil-filled compensating capsule may be a differential compensating capsule having a first side and/or a second side in communication with the main input port.

In certain implementations, the oil-filled compensating capsule may be a differential compensating capsule having a first side and/or a second side in communication with the reference input port.

In some implementations, the various combinations of the (differential and/or single ended) pressure sensing and compensating capsules can include equal volumes of oil. In some implementations, the various combinations of the (differential and/or single ended) pressure sensing and compensating capsules may be attached to the housing in a same (or common) orientation.

In accordance with certain example implementations of the disclosed technology, the (differential and/or single ended) pressure sensing and compensating capsules can each include one or more equivalent deflectable membrane diaphragms, Wheatstone bridges comprising piezoresistors, evacuated and sealed oil-filled cavities, and/or protective diaphragms in communication with the oil-filled cavities.

In accordance with certain example implementations of the disclosed technology, the compensation circuit may include at least one voltage source configured to bias one or more of the (differential and/or single ended) pressure sensing and/or compensating capsules to reduce the difference between the common error signal and the compensation signal.

In certain example implementations, the compensation circuit may include one or more passive interconnects configured to output the difference between the pressure and common error signals.

In accordance with certain example implementations of the disclosed technology, the compensation circuit may include one or more active electronic components configured to output the compensated pressure output signal based on a subtraction of the compensation signal measured by the compensating capsule from the pressure and common error signal measured by the differential oil-filled pressure sensing capsule.

In accordance with certain example implementations of the disclosed technology, the compensation circuit can include one or more voltage-follower input buffers. In accordance with certain example implementations of the disclosed technology, the compensation circuit can include a differential amplifier in communication with the one or more voltage-follower input buffers.

According to an example implementation of the disclosed technology, the oil-filled pressure sensing capsule and the oil-filled compensating capsule may each include an equivalent membrane diaphragm having the same mass and configuration.

It is important to recognize that it is impractical to describe every conceivable combination of components or methodologies for purposes of describing the claimed subject matter. However, a person having ordinary skill in the art will recognize that many further combinations and permutations of the subject technology are possible. Accordingly, the claimed subject matter is intended to cover all such alterations, modifications, and variations that are within the spirit and scope of the claimed subject matter.

Throughout the specification and the claims, the following terms take at least the meanings explicitly associated herein, unless the context clearly dictates otherwise. The term “connect,” “connecting,” and “connected” mean that one function, feature, structure, or characteristic is directly joined to or in communication with another function, feature, structure, or characteristic. The terms “couple,” “coupling,” and “coupled” mean that one function, feature, structure, or characteristic is directly or indirectly joined to or in communication with another function, feature, structure, or characteristic. Relational terms such as “first” and “second,” and the like may be used solely to distinguish one entity or action from another entity or action without necessarily requiring or implying any actual such relationship or order between such entities or actions. The term “or” is intended to mean an inclusive “or.” Further, the terms “a,” “an,” and “the” are intended to mean one or more unless specified otherwise or clear from the context to be directed to a singular form. The term: “include” and its various forms are intended to mean including but not limited to. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way but may also be configured in ways that are not listed.

Ranges have been expressed herein as from “about” or “approximately” one particular value and/or to “about” or “approximately” another particular value. When such a range is expressed, an embodiment includes values from the one particular value (starting point) and/or to the other particular value (ending point). In certain embodiments, the term “about” signifies a buffer of +/−10% of the said range about each said starting point and/or ending point. In certain embodiments, the term “about” signifies a buffer of +/−5% of the said range about each said starting point and/or ending point.

As disclosed herein, numerous specific details are set forth. However, it is to be understood that embodiments of the disclosed technology may be practiced without these specific details. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may.

Although this disclosure describes specific examples, embodiments, and the like, certain modifications and changes may be made without departing from the scope of the disclosed technology, as set forth in the claims below. For example, although the example methods, devices and systems, described herein are in conjunction with a pressure transducer or a sensor, the skilled artisan will readily recognize that the example methods, devices or systems may be used in other methods, devices or systems and may be configured to correspond to such other example methods, devices or systems as needed. Further, while at least one example, embodiment, or the like has been presented in the detailed description, many variations exist. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments or examples are not intended to be construed as a critical, required, or essential feature or element of any or all of the claims.

1. A compensated oil-filled differential pressure transducer assembly, comprising:
a main input port configured to receive a main pressure;
a reference input port configured to receive a reference pressure;
an oil-filled differential pressure sensing capsule configured to output a differential pressure signal responsive to the main pressure received at the main input port and the reference pressure received at the reference input port, and a common error signal responsive to a common stimulus acting on the oil-filled differential pressure sensing capsule;
an oil-filled compensating capsule configured to output a compensation signal responsive to the common stimulus; and
a compensation output circuit in communication with the oil-filled differential pressure sensing capsule and the oil-filled compensating capsule, the compensation output circuit configured to output a compensated pressure output signal based on a difference between the differential pressure signal and the common error signal of the oil-filled differential pressure sensing capsule and the compensation signal of the oil-filled compensating capsule.

2. The assembly of claim 1, wherein the oil-filled compensating capsule is a differential compensating capsule.

3. The assembly of claim 1, wherein the oil-filled compensating capsule is isolated from the main input port and the reference input port.

4. The assembly of claim 1, wherein the oil-filled compensating capsule is in communication with the main input port.

5. The assembly of claim 4, wherein the oil-filled compensating capsule is a differential compensating capsule, and wherein both a first side and a second side of the differential compensating capsule are in communication with the main input port.

6. The assembly of claim 1, wherein the oil-filled compensating capsule is in communication with the reference input port.

7. The assembly of claim 6, wherein the oil-filled compensating capsule is a differential compensating capsule, and wherein both a first side and a second side of the differential compensating capsule are in communication with the reference input port.

8. The assembly of claim 1, wherein the oil-filled differential pressure sensing capsule and the oil-filled compensating capsule are attached to a housing in a side-by-side arrangement.

9. The assembly of claim 1, wherein the oil-filled differential pressure sensing capsule and the oil-filled compensating capsule are attached to a housing in a vertically stacked arrangement.

10. The assembly of claim 1, wherein the oil-filled differential pressure sensing capsule and the oil-filled compensating capsule include equal volumes of oil and are attached to a housing in a same orientation.

11. The assembly of claim 1, wherein both the oil-filled differential pressure sensing capsule and the oil-filled compensating capsule each include one or more:
deflectable membrane diaphragms;
Wheatstone bridges comprising piezoresistors;
oil-filled cavities; and
protective diaphragms in communication with the oil-filled cavities.

12. The assembly of claim 1, wherein the compensation output circuit includes one or more passive interconnects configured to output the difference between the differential pressure signal and the common error signal of the oil-filled differential pressure sensing capsule and the compensation signal of the oil-filled compensating capsule, and wherein the compensation output circuit is configured to bias one or more of a first transducer of the oil-filled differential pressure sensing capsule and a second transducer of the oil-filled compensating capsule to reduce the difference between the common error signal and the compensation signal.

13. The assembly of claim 1, wherein the compensation output circuit includes:
one or more active electronic components configured to output the compensated pressure output signal based on a subtraction of the compensation signal measured by the oil-filled compensating capsule from the differential pressure signal and the common error signal measured by the oil-filled differential pressure sensing capsule.

14. The assembly of claim 13, wherein the compensation output circuit comprises two voltage-follower input buffers and a differential amplifier in communication with the two voltage-follower input buffers.

15. The assembly of claim 1, wherein the common stimulus comprises one or more of vibration, acceleration, and temperature.

16. A compensated oil-filled differential pressure transducer assembly, comprising:
a main input port configured to receive a main pressure;
a reference input port configured to receive a reference pressure;
an oil-filled main pressure sensing capsule configured to output a main pressure signal responsive to the main pressure received at the main input port and a first common error signal responsive to a common stimulus acting on the oil-filled main pressure sensing capsule, the oil-filled main pressure sensing capsule comprising a main pressure sensing element in communication with the main input port; and
an oil-filled reference pressure sensing capsule mounted in a same orientation as the oil-filled main pressure sensing capsule, the oil-filled reference pressure sensing capsule configured to output a reference pressure signal responsive to the reference pressure received at the reference input port and a second common error signal responsive to the common stimulus acting on the oil-filled reference pressure sensing capsule, the oil-filled reference pressure sensing capsule comprising a reference pressure sensing element in communication with the reference input port.

17. The assembly of claim 16, further comprising a compensation circuit configured to output a compensated pressure output signal based on a difference between the main pressure signal and the reference pressure signal.

18. The assembly of claim 17, wherein the compensation circuit is configured to bias one or more of the main pressure sensing element and the reference pressure sensing element.

19. The assembly of claim 16, wherein the oil-filled main pressure sensing capsule and the oil-filled reference pressure sensing capsule each comprise a sealable oil-filling tube configured for filling and sealing an oil cavity.

20. The assembly of claim 16, wherein the oil-filled main pressure sensing capsule and the oil-filled reference pressure sensing capsule are configured substantially equivalent to each other.
